(19) United States
(12) Patent Application Publication
(10) Pub. No.: US 2019/0195716 A1
(43) Pub. Date: Jun. 27, 2019

(54) PRESSURE SENSOR

(71) Applicant: MIKUNI CORPORATION, Tokyo (JP)

(72) Inventor: Katsuhiko FUKUI, Iwate (JP)

(73) Assignee: MIKUNI CORPORATION, Tokyo (JP)

(21) Appl. No.: 16/228,781

(22) Filed: Dec. 21, 2018

(30) Foreign Application Priority Data
Dec. 22, 2017 (JP) 2017-246118

(51) Int. Cl. G01L 9/00; G01L 19/04; G01L 23/10; G01L 23/22

(52) U.S. Cl. CPC G01L 9/008; G01L 9/0044; G01L 9/006; G01L 2019/0053; G01L 23/10; G01L 23/22; G01L 19/04

(57) ABSTRACT

Provided is a pressure sensor capable of minimizing an influence of heat and accurately detecting a pressure of a high temperature pressure medium. The pressure sensor includes a housing including a tubular tip portion, a pressure measuring part including a piezoelectric substance while being accommodated in the housing, and a diaphragm including a flexible plate-shaped section fixed to an inner side of the tubular tip portion and a rod section interposed between the flexible plate-shaped section and the pressure measuring part, wherein a heat shield plate held on the inner side of the tubular tip portion to shield the diaphragm from a pressure medium is provided. Accordingly, an influence of heat can be minimized, and a pressure of a high temperature pressure medium can be accurately detected.

### CROSS-REFERENCE TO RELATED APPLICATION

This application claims the priority of Japan patent application serial no. 2017-246118, filed on Dec. 22, 2017. The entirety of the above-mentioned patent application is hereby incorporated by reference herein and made a part of this specification.

### BACKGROUND

### Technical Field

The disclosure relates to a pressure sensor configured to detect a pressure of a pressure medium, and more particularly, to a pressure sensor configured to detect a pressure of a high temperature pressure medium such as a combustion gas or the like in a combustion chamber of an engine.

### Description of Related Art

As a pressure sensor in the related art, a pressure sensor including a tubular housing, a diaphragm bonded to a tip side of the housing and bent according to the received pressure, a sensor part disposed in the housing, a connecting part configured to connect the diaphragm to the sensor part, and a heat receiving part serving as a heat shield plate connected to a substantially central section of an outer surface of the diaphragm through welding is known (for example, Patent Document 1).

In this pressure sensor, when the diaphragm is deformed in an outward convex shape due to a preload upon assembly, a gap is generated between the diaphragm and the heat shield plate in an outer circumferential region of the diaphragm. The diaphragm is directly exposed to a high temperature pressure medium through the gap, and thus, the diaphragm cannot minimize or prevent an influence of heat.

In addition, since the heat shield plate is fixed to the diaphragm through welding, X-ray radiography, a destruction test, or the like, is needed to guarantee a welding strength, an increase in management man-hours and management costs occurs, and the heat shield plate is limited to a metal material.

### PATENT DOCUMENTS

[Patent Document 1] Japanese Laid-open No. 2017-40516

### SUMMARY

A pressure sensor of an embodiment of the disclosure includes a housing including a tubular tip portion; a pressure measuring part including a piezoelectric substance while being accommodated in the housing; a diaphragm including a flexible plate-shaped section fixed to an inner side of the tubular tip portion and a rod section interposed between the flexible plate-shaped section and the pressure measuring part; and a heat shield plate held on an inner side of the tubular tip portion to shield the diaphragm from a pressure medium.

### BRIEF DESCRIPTION OF THE DRAWINGS

FIG. 1 is a cross-sectional view showing an embodiment of a pressure sensor according to the disclosure.

FIG. 2 is a partially enlarged cross-sectional view showing a housing including a tubular tip portion, a diaphragm, a heat shield plate, a pressure measuring part, and so on, in the pressure sensor shown in FIG. 1.

FIG. 3 is a partially enlarged cross-sectional view showing a mutual relationship between the tubular tip portion, the diaphragm and the heat shield plate in the pressure sensor shown in FIG. 1.

FIG. 4 is a partially enlarged cross-sectional view showing the tubular tip portion, the diaphragm and the heat shield plate in states before and after folding processing is performed on an opening edge region of the tubular tip portion in the pressure sensor shown in FIG. 1.

FIG. 5 is a cross-sectional view showing another embodiment of the pressure sensor according to the disclosure.

FIG. 6 is a partially enlarged cross-sectional view showing the housing including the tubular tip portion, the diaphragm, the heat shield plate, the pressure measuring part, and so on, in the pressure sensor shown in FIG. 5.

FIG. 7 is a partially enlarged cross-sectional view showing a mutual relationship between the tubular tip portion, the coupling member, the diaphragm, and the heat shield plate in the pressure sensor shown in FIG. 5.

FIG. 8 is a partially enlarged cross-sectional view showing the tubular tip portion, the diaphragm, the coupling member, and the heat shield plate in states before and after a coupling member that defines a part of the tubular tip portion is coupled to the housing in the pressure sensor shown in FIG. 5.

FIG. 9 is a graph in which sensor outputs are compared with the pressure sensor according to the embodiment of the disclosure and the pressure sensor in the related art.

### DESCRIPTION OF THE EMBODIMENTS

The embodiments of the disclosure are directed to providing a pressure sensor capable of securely shielding a diaphragm from a high temperature pressure medium, minimizing an influence of heat and accurately detecting a pressure of the high temperature pressure medium.

A pressure sensor of an embodiment of the disclosure includes a housing including a tubular tip portion; a pressure measuring part including a piezoelectric substance while being accommodated in the housing; a diaphragm including a flexible plate-shaped section fixed to an inner side of the tubular tip portion and a rod section interposed between the flexible plate-shaped section and the pressure measuring part; and a heat shield plate held on an inner side of the tubular tip portion to shield the diaphragm from a pressure medium.

In the pressure sensor having this configuration, the tubular tip portion may include an annular tip portion that defines an opening having a reduced diameter at a tip thereof, and the heat shield plate may be held by the annular tip portion.

In the pressure sensor having this configuration, the annular tip portion may be formed by folding an opening edge region of the tubular tip portion inward.

In the pressure sensor having this configuration, the heat shield plate may be held to come in contact with the flexible plate-shaped section with no load or faces the flexible plate-shaped section with a predetermined play gap therebetween in a state in which a pressure of a pressure medium is not received.

In the pressure sensor having this configuration, the play gap may be set be in a range of a plate thickness or less of the heat shield plate.

In the pressure sensor having this configuration, the tubular tip portion may be formed in a cylindrical shape, the flexible plate-shaped section may be formed in a disk shape disposed on an inner side of the tubular tip portion, and the heat shield plate may be formed in a disk shape having an outer diameter smaller than an inner diameter of the tubular tip portion.

In the pressure sensor having this configuration, the tubular tip portion may include a first tubular section, a second tubular section disposed on a tip side of the first tubular section and having a wall thickness smaller than that of the first tubular section, and a stepping surface formed on a boundary between the first tubular section and the second tubular section, the flexible plate-shaped section may be fixed to the stepping surface, the second tubular section may include an annular tip portion that defines an opening having a reduced diameter at a tip thereof, and the heat shield plate may be held by the annular tip portion.

In the pressure sensor having this configuration, the annular tip portion may be constituted by a coupling member coupled to the housing to define the second tubular section.

In the pressure sensor having this configuration, the pressure measuring part may include a first electrode, a piezoelectric substance and a second electrode, which are sequentially laminated from a tip side of the tubular tip portion, and the diaphragm may function as the first electrode.

According to the pressure sensor having this configuration, it is possible to provide a pressure sensor capable of minimizing an influence of heat and accurately detecting a pressure of a high temperature pressure medium.

Hereinafter, embodiments of the disclosure will be described with reference to the accompanying drawings.

A pressure sensor according to the first embodiment is attached to a cylinder head H of an engine, and detects a pressure of a combustion gas in a combustion chamber as a pressure medium.

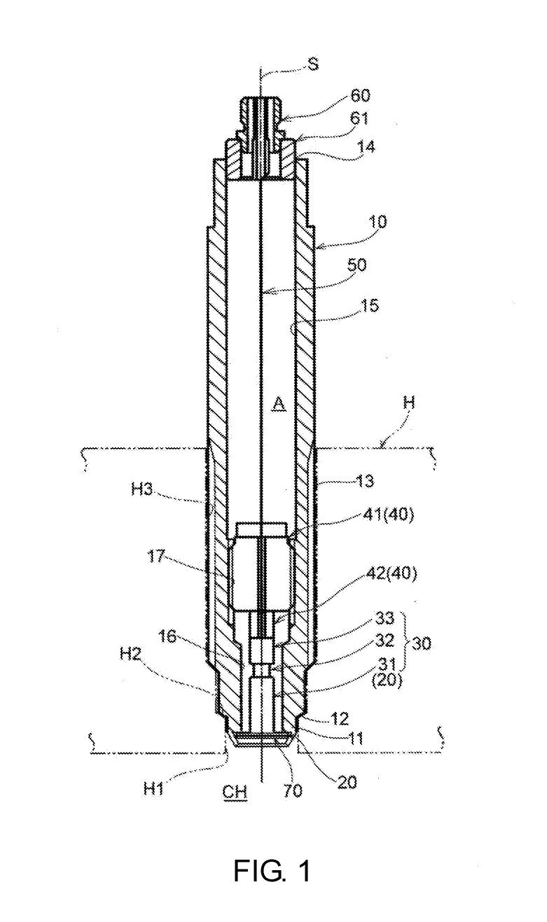

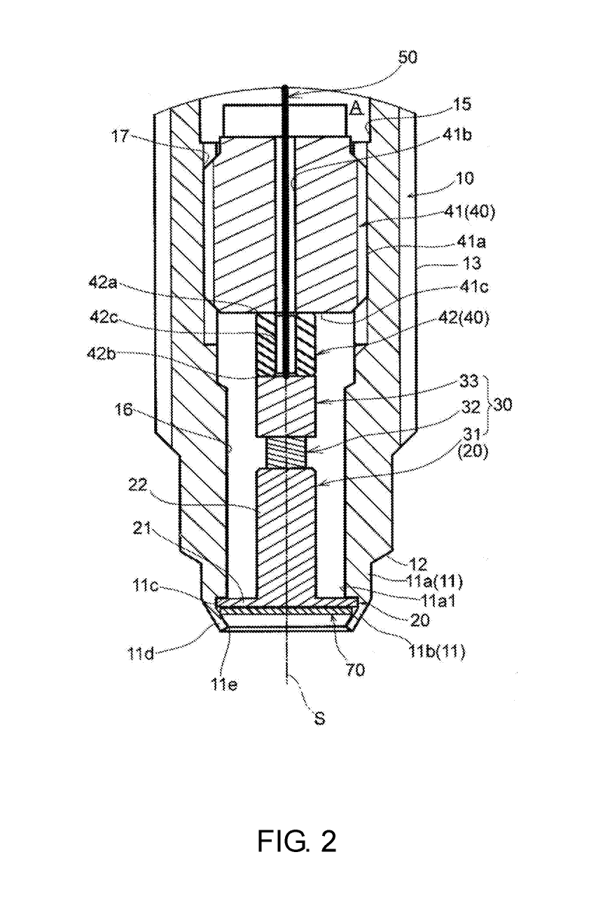

As shown in FIG. 1 and FIG. 2, the pressure sensor includes a housing 10, a diaphragm 20, a pressure measuring part 30, a pressing member 40, a lead wire 50, a connector 60, and a heat shield plate 70.

The housing 10 is formed in a multi-stage cylindrical shape that defines an internal space A extending in an axis S direction using a metal material such as a precipitation hardening-based or ferrite-based stainless steel, or the like.

Further, the housing 10 includes a tubular tip portion 11, a seal section 12, a male screw section 13, an opening end portion 14, inner wall surfaces 15 and 16, and a female screw section 17.

The tubular tip portion 11 is formed in a cylindrical shape having a two-stage wall thickness in a region disposed on a tip side in the axis S direction of the seal section 12, and includes a first tubular section 11a, a second tubular section 11b, a stepping surface 11c, an annular tip portion 11d, and an opening 11e defined by the annular tip portion 11d.

The first tubular section 11a defines an inner wall surface 11a1 having a cylindrical shape, and an outer wall surface thereof is disposed to close to or be in close contact with an inner circumferential surface H1 of an attachment hole of the cylinder head H such that the outer wall surface cannot be easily exposed to a combustion gas.

The second tubular section 11b defines a cylindrical inner wall surface 11b1 having a thickness smaller than that of the first tubular section 11a in a state before folding processing. The stepping surface 11c is formed as an annular plane perpendicular to an axis S in a boundary between the first tubular section 11a and the second tubular section 11b.

Then, the stepping surface 11c functions as a fixing surface that fixes a flexible plate-shaped section 21 of the diaphragm 20 through welding or the like.

The annular tip portion 11d is folded by folding an opening edge region of the second tubular section 11b inward, and defines the circular opening 11e in a central region thereof.

The opening 11e has a diameter smaller than an outer diameter D of the heat shield plate 70, i.e., is formed to have a small inner diameter.

That is, the annular tip portion 11d plays a role of holding the heat shield plate 70 accommodated inside the second tubular section 11b such that the heat shield plate 70 does not fall.

The seal section 12 is formed in a conical surface shape at a predetermined position retracted from a tip of the tubular tip portion 11 in the axis S direction, and abuts a seal surface H2 of the cylinder head H to play a role of preventing leakage of a combustion gas in a combustion chamber CH.

The male screw section 13 is threadedly engaged with a female screw section H3 of an attachment hole formed in the cylinder head H to fix the housing 10, and formed in a diameter-enlarged region retracted from the seal section 12 in the axis S direction.

The opening end portion 14 functions as an insertion port when the pressing member 40 or the like is attached therethrough, and is formed such that the connector 60 is fixed thereto via a spacer 61.

The inner wall surface 15 is formed as a cylindrical inner circumferential surface that forms an inner diameter dimension such that the pressing member 40 can be inserted therethrough.

The inner wall surface 16 is formed as a cylindrical inner circumferential surface that forms an inner diameter dimension having a diameter smaller than that of the inner wall surface 15, and the pressure measuring part 30 is accommodated in this region.

The female screw section 17 is formed in a region between the inner wall surface 15 and the inner wall surface 16 such that the pressing member 40 can be fixed by being screwed with the female screw section 17.

The diaphragm 20 is formed using a metal material such as stainless steel or the like having a precipitation hardening property.

Then, the diaphragm 20 includes the flexible plate-shaped section 21, and a rod section 22 formed to be continuous with the flexible plate-shaped section 21.

The flexible plate-shaped section 21 is formed in a disk shape having a plate thickness t1, and an outer edge region thereof is fixed to the stepping surface 11c of the tubular tip portion 11 through welding or the like.

The flexible plate-shaped section 21 is a region to which a load according to a pressure of a combustion gas is transmitted via the heat shield plate 70 and is elastically deformed in the axis S direction according to the load.

Here, the plate thickness t1 of the flexible plate-shaped section 21 is about 0.2 mm to 0.6 mm.

The rod section 22 is formed in a columnar shape extending from a substantially central region of the flexible plate-shaped section 21 in the axis S direction.

Then, an outer circumferential surface of the rod section 22 is disposed such that a gap between it and the inner wall surfaces 11a1 and 16 of the housing 10 is provided, and an end surface of the rod section 22 is disposed to abut a piezoelectric substance 32 of the pressure measuring part 30.

That is, the rod section 22 is interposed between the flexible plate-shaped section 21 and the piezoelectric substance 32 of the pressure measuring part 30 and has a function of transmitting a force received by the flexible plate-shaped section 21 to the piezoelectric substance 32.

The pressure measuring part 30 functions as a piezoelectric element, and as shown in FIG. 2, includes a first electrode 31, the piezoelectric substance 32 and a second electrode 33, which are sequentially stacked from a tip side of the tubular tip portion 11 in the axis S direction.

The first electrode 31 is formed of a conductive metal material, and in the embodiment, the diaphragm 20 functions as the first electrode 31.

Then, the first electrode 31, i.e., the diaphragm 20 is disposed such that the rod section 22 is in close contact with the piezoelectric substance 32, and electrically connected to a ground (a negative side) via the housing 10 and the cylinder head H.

The piezoelectric substance 32 is formed in a rectangular columnar shape, sandwiched between the rod section 22 of the first electrode 31, i.e., the diaphragm 20 and the second electrode 33, and outputs an electrical signal on the basis of distortion due to a load received in the axis S direction, and a piezoelectric element, zinc oxide, a crystal, or the like, is applied thereas.

The second electrode 33 is formed of a conductive metal material in a columnar or disk shape, disposed to be in close contact with the piezoelectric substance 32, and electrically connected to a positive side via the lead wire 50.

In the pressure measuring part 30, since the diaphragm 20 functions as the first electrode 31, in comparison with the case in which a dedicated electrode is provided, the number of parts can be reduced, and a structure can be simplified.

Further, the disclosure is not limited to this configuration, and a separate electrode from the diaphragm 20 may be included as the first electrode 31.

As shown in FIG. 2, the pressing member 40 is constituted by a screw member 41 and an insulating member 42.

The screw member 41 is formed of a metal material such as a precipitation hardening-based or ferrite-based stainless steel or the like in a substantially columnar shape, and includes a male screw section 41a threadedly engaged with the female screw section 17 of the housing 10, a through-hole 41b through which the lead wire 50 passes, and an abutting surface 41c that abuts the insulating member 42.

The insulating member 42 is formed of an insulating material having highly electrically insulating properties, for example, alumina or the like, in a substantially circumferential shape and includes an end surface 42a that abuts the abutting surface 41c of the screw member 41, an end surface 42b that abuts the second electrode 33, and a through-hole 42c through which the lead wire 50 passes.

Then, as shown in FIG. 1 and FIG. 2, as the insulating member 42 is inserted in a state in which the pressure measuring part 30 is disposed at a predetermined position and the screw member 41 is screwed from above the insulating member 42, a preload being applied to the pressure measuring part 30 in the axis S direction or the pressure measuring part 30 being positioned and held at a predetermined position in the housing 10.

As shown in FIG. 1, the lead wire 50 is electrically connected to the second electrode 33 of the pressure measuring part 30, passes through the through-hole 42c of the insulating member 42, the through-hole 41b of the screw member 41 and the internal space A of the housing 10, and is guided to the connector 60.

The connector 60 is formed as a receptacle, coupled to the opening end portion 14 of the housing 10 via the spacer 61, and detachably connected to an external connector (plug).

The heat shield plate 70 is disposed inside the tubular tip portion 11 such that the diaphragm 20 is shielded from a combustion gas that is a pressure medium, and formed of a material having a heat resistance and a low thermal conductivity, for example, a stainless steel plate in a disk shape.

Here, a plate thickness t2 of the heat shield plate 70 is, for example, about 0.2 mm to 0.5 mm.

As a material of the heat shield plate 70, a material having a low thermal conductivity, good durability and high rigidity is adopted, for example, and in addition to stainless steel, carbon steel on which nickel plating has been performed, a nickel alloy, an iron-based alloy, a titanium alloy, or the like, may be used.

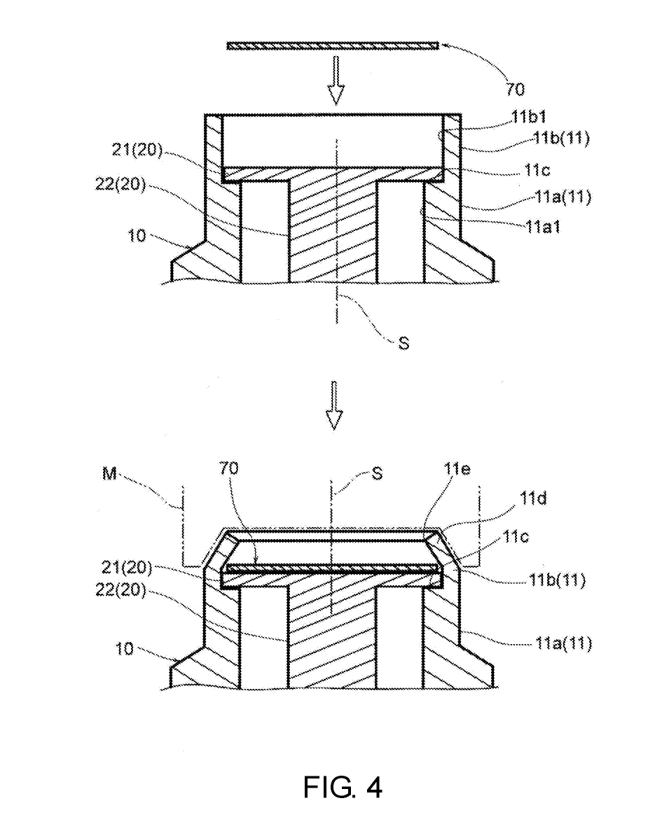

Then, as shown in FIG. 4, the heat shield plate 70 is inserted inside the second tubular section 11b of the tubular tip portion 11, and then, held on an inner side of the second tubular section 11b such that the heat shield plate 70 does not fall outward by the annular tip portion 11d formed by bending an opening edge region of the second tubular section 11b inward using a folding machine M.

Here, the heat shield plate 70 is held in contact with the flexible plate-shaped section 21 with no load in a state in which a pressure of a combustion gas is not being received.

In addition, the outer diameter D of the heat shield plate 70 is larger than an effective diameter of the flexible plate-shaped section 21 that functions as a diaphragm and smaller than an inner diameter of the second tubular section 11b such that the heat shield plate 70 does not become immovable inside the second tubular section 11b due to scuffing, sticking, or the like.

Further, while the heat shield plate 70 is held to be in contact with the flexible plate-shaped section 21 with no load, the heat shield plate 70 may be disposed to face the flexible plate-shaped section 21 with a predetermined play gap therebetween in the axis S direction.

In this case, the play gap is set to be in a range of the plate thickness t2 or less of the heat shield plate 70, specifically, about 0.1 to 0.2 mm.

In this way, since the play gap is provided, there is no need to accurately manage the folding processing such that the heat shield plate 70 is pressed against the flexible plate-shaped section 21 and does not exert a load.

Next, assembly of a pressure sensor that constitutes the configuration will be described.

First, the housing 10, the diaphragm 20, the piezoelectric substance 32, the second electrode 33 to which the lead wire 50 is connected, the screw member 41, the insulating member 42, the connector 60, the spacer 61, and the heat shield plate 70 are prepared.

Next, the diaphragm 20 is assembled on the housing 10.

That is, the flexible plate-shaped section 21 is joined to the stepping surface 11c of the tubular tip portion 11 and fixed thereto through welding or the like.

Next, the piezoelectric substance 32, the second electrode 33, the insulating member 42 and the screw member 41 are inserted into the housing 10 from the opening end portion 14 to overlap each other in sequence.

Further, the piezoelectric substance 32, the second electrode 33 and the insulating member 42 may be previously stacked and temporarily assembled.

Then, the screw member 41 is appropriately screwed, and a predetermined preload is applied to provide linear characteristics to the pressure measuring part 30 as a sensor.

Next, the spacer 61 is fixed to the opening end portion 14 of the housing 10, an extracted lead wire 50 is connected to the connector 60, and the connector 60 is connected to the spacer 61.

Next, the heat shield plate 70 is attached to be held inside the tubular tip portion 11 of the housing 10. Here, “holding” means that a member is supported such that it does not fall without being immovably fixed to the tubular tip portion 11.

That is, the heat shield plate 70 is disposed on an inner side of the second tubular section 11b of the tubular tip portion 11.

Next, as shown in FIG. 4, an opening edge region of the second tubular section 11b is folded inward using the predetermined folding machine M, and the annular tip portion 11d is formed. Here, the opening 11e having a diameter smaller than the outer diameter D of the heat shield plate 70 is defined by the annular tip portion 11d.

As described above, assembly of the pressure sensor is terminated.

Further, this assembly sequence is merely an example and is not limited thereto, and another assembly sequence may be employed.

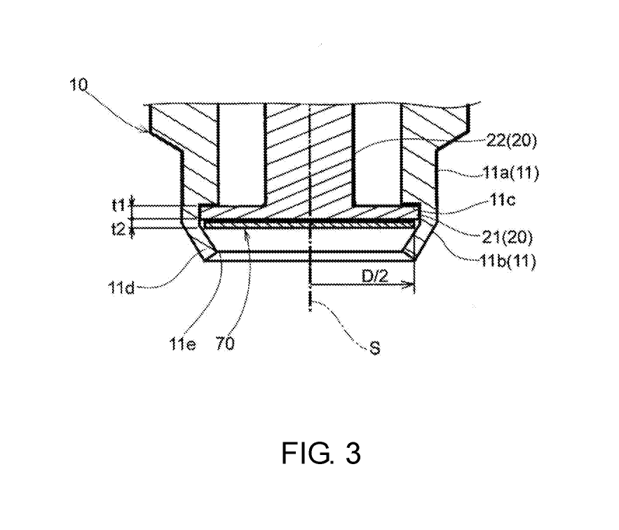

In the pressure sensor that constitutes this configuration, the tubular tip portion 11, the diaphragm 20 and the heat shield plate 70 have a disposition relationship shown in FIG. 3.

That is, the heat shield plate 70 is held inside the tubular tip portion 11 and disposed on an outer side of the diaphragm 20 such that the heat shield plate 70 is in contact with the flexible plate-shaped section 21 with no load in a state in which a pressure of a combustion gas is not being received.

Accordingly, when the heat shield plate 70 receives a pressure of a combustion gas through the opening 11e, the load according to the pressure is immediately applied to the flexible plate-shaped section 21 via the heat shield plate 70. Then, the diaphragm 20 deforms according to the received load while being shielded from the combustion gas by the heat shield plate 70.

Accordingly, heat of the combustion gas is substantially shielded by the heat shield plate 70, and heat transfer toward the diaphragm 20 is minimized or prevented. Accordingly, in the flexible plate-shaped section 21 of the diaphragm 20, an influence of heat due to a combustion gas is minimized or prevented, and only a pressure of a combustion gas is substantially received.

In addition, since the heat shield plate 70 is disposed to come in contact with the flexible plate-shaped section 21, no impact force or impact sound according to the movement occurs, and there is no influence on characteristics of the diaphragm 20.

In addition, the heat shield plate 70 is held on an inner side of the tubular tip portion 11 and not fixed through welding or the like. Accordingly, as a material of the heat shield plate 70, materials other than a metal material may be used as long as a heat shielding action is obtained by the material.

As described above, even in a measurement environment exposed to a high temperature pressure medium, deformation of the diaphragm 20 due to heat can be minimized, and a contact position between the rod section 22 of the diaphragm 20 and the piezoelectric substance 32 of the pressure measuring part 30 can be maintained in an expected setting state.

Accordingly, fluctuation of a preload applied to the pressure measuring part 30 can be prevented, and output noise from the piezoelectric substance 32 due to fluctuation of a preload can be prevented.

For this reason, measurement error due to thermal deformation or the like can be minimized, and a pressure of a combustion gas in the combustion chamber CH of the engine can be accurately detected.

That is, when the diaphragm 20 is temporarily deformed by heat as a mechanism, while a preload applied to the pressure measuring part 30 varies and the accuracy of the detected pressure is decreased, in the embodiment of the disclosure, since deformation of the diaphragm 20 due to heat is minimized by the heat shield plate 70, the pressure can be accurately detected by heat shielding→minimization of thermal deformation of the diaphragm 20→prevention of fluctuation of a preload.

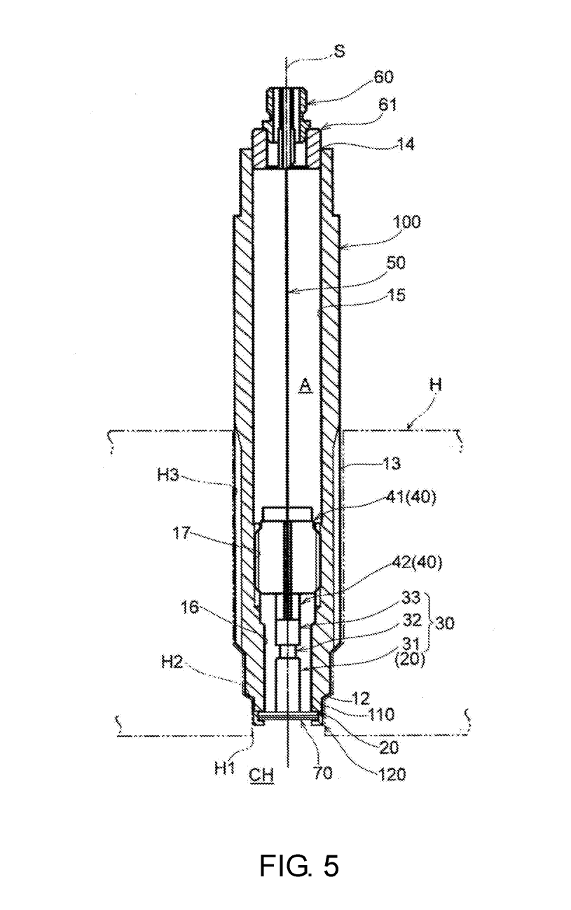

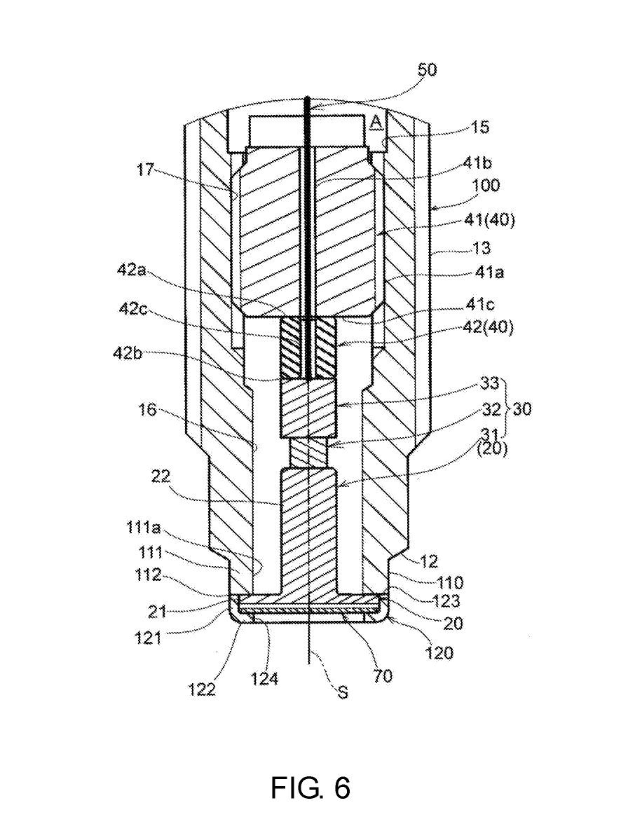

FIG. 5 to FIG. 8 show another embodiment of the pressure sensor according to the disclosure, constituting the same configuration as the above-mentioned embodiment except that the second tubular section 11b holding the above-mentioned heat shield plate 70 is changed. Accordingly, components which are the same are designated by the same reference numerals and description thereof will be omitted.

The pressure sensor according to the embodiment includes a housing 100, the diaphragm 20, the pressure measuring part 30, the pressing member 40, the lead wire 50, the connector 60 and the heat shield plate 70.

The housing 100 is formed in a multi-stage cylindrical shape that defines the internal space A extending in the axis S direction using a metal material such as a precipitation hardening-based or ferrite-based stainless steel or the like.

Then, the housing 100 includes a tubular tip portion 110, the seal section 12, the male screw section 13, the opening end portion 14, the inner wall surfaces 15 and 16, the female screw section 17, and a coupling member 120 coupled to the tubular tip portion 110.

The tubular tip portion 110 is formed in a cylindrical shape having a two-stage thickness in a region disposed from the seal section 12 toward a tip side in the axis S direction, and includes a first tubular section 111, an end surface 112, and the coupling member 120 coupled to the end surface 112.

Then, the coupling member 120 includes a second tubular section 121 coupled to the first tubular section 111 such that an outer circumferential wall is continuous, an annular tip portion 122 formed on a tip side of the second tubular section 121, an end surface 123 formed on a rear end side of the second tubular section 121, and an opening 124 defined by the annular tip portion 122.

The first tubular section 111 defines an inner wall surface 111a having a cylindrical shape, and an outer wall surface thereof is disposed to close to or be in close contact with the inner circumferential surface H1 of the attachment hole of the cylinder head H such that the outer wall surface cannot be easily exposed to a combustion gas.

The end surface 112 defines a stepping surface that forms an annular plane perpendicular to the axis S at a boundary between the first tubular section 111 and the second tubular section 121 in a state in which the first tubular section 111 and the second tubular section 121 are coupled to each other.

Then, the stepping surface disposed in an inner edge region of the end surface 112 functions as a fixing surface to which the flexible plate-shaped section 21 of the diaphragm 20 is fixed through welding or the like.

The second tubular section 121 defines an inner wall surface 121a having a cylindrical shape with a wall thickness smaller than that of the first tubular section 111. An inner diameter of the inner wall surface 121a is slightly larger than the outer diameter D of the heat shield plate 70.

The annular tip portion 122 is formed in an annular disk shape on a tip side of the second tubular section 121, and defines the circular opening 124 in a central region thereof.

The end surface 123 is formed in an annular planar shape and coupled to an outer circumferential edge region of the end surface 112.

The opening 124 is formed to have a diameter smaller than the inner diameter of the second tubular section 121 as the tubular tip portion such that the inner diameter of the opening 124 is smaller than the outer diameter D of the heat shield plate 70.

That is, the annular tip portion 122 plays a role of holding the heat shield plate 70 accommodated on an inner side of the second tubular section 121 such that the heat shield plate 70 is movable in the axis S direction and does not fall.

Here, the heat shield plate 70 is held to face the flexible plate-shaped section 21 with a predetermined play gap C therebetween in a state in which a pressure of a combustion gas is not received.

Here, the play gap C is set to be in a range of the plate thickness t2 or less of the heat shield plate 70, specifically, about 0.1 to 0.2 mm.

In addition, the outer diameter D of the heat shield plate 70 is larger than an effective diameter of the flexible plate-shaped section 21 that functions as a diaphragm and smaller than the inner diameter of the second tubular section 121 such that the heat shield plate 70 is not immovable due to scuffing, sticking, or the like or does not cause an increase in resistance due to sliding on an inner side of the second tubular section 121.

Further, the heat shield plate 70 may be held to come in contact with the flexible plate-shaped section 21 with no load in a state in which a load is not being applied.

Next, assembly of the pressure sensor that constitutes the configuration will be described.

First, the housing 100, the coupling member 120, the diaphragm 20, the piezoelectric substance 32, the second electrode 33 to which the lead wire 50 is connected, the screw member 41, the insulating member 42, the connector 60, the spacer 61 and the heat shield plate 70 are prepared.

Next, the diaphragm 20 is assembled on the housing 100. That is, the flexible plate-shaped section 21 is coupled and fixed to the end surface 112 of the tubular tip portion 110 through welding or the like.

Next, the piezoelectric substance 32, the second electrode 33, the insulating member 42 and the screw member 41 are inserted into the housing 100 from the opening end portion 14 to sequentially overlap each other.

Further, the piezoelectric substance 32, the second electrode 33 and the insulating member 42 may be previously laminated and temporarily assembled together.

Then, the screw member 41 is appropriately screwed and a predetermined preload is applied to provide linear characteristics to the pressure measuring part 30 as a sensor.

Next, the spacer 61 is fixed to the opening end portion 14 of the housing 100, the extracted lead wire 50 is connected to the connector 60, and the connector 60 is connected to the spacer 61.

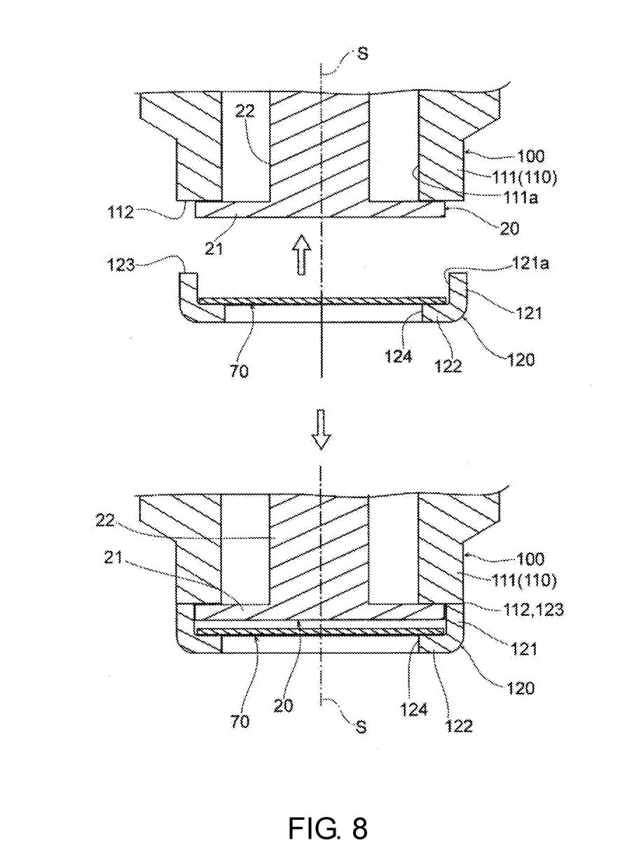

Next, as shown in FIG. 8, in a state in which the heat shield plate 70 is accommodated inside the coupling member 120, the end surface 123 of the coupling member 120 is coupled and fixed to the end surface 112 of the tubular tip portion 110 through welding or the like.

Accordingly, the heat shield plate 70 is assembled to be held on an inner side of the tubular tip portion 110 of the housing 100.

Here, “holding” means that a member is supported such that it does not fall without being immovably fixed to the tubular tip portion 110 and movable in the axis S direction.

As described above, assembly of the pressure sensor is terminated.

Further, the assembly sequence is an example and not limited thereto, and another assembly sequence may be employed.

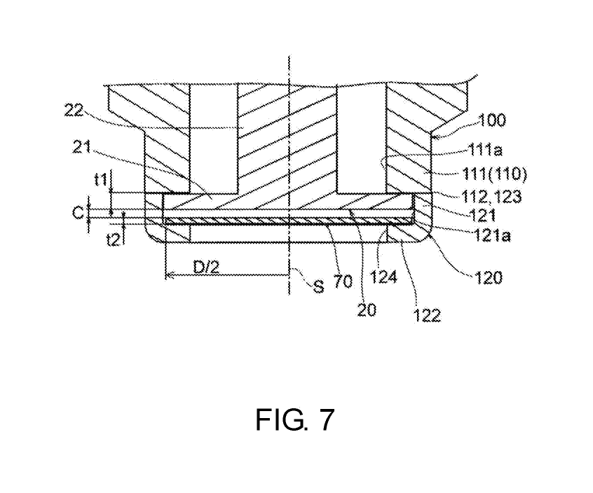

In the pressure sensor that constitutes the configuration, the tubular tip portion 110, the diaphragm 20, and the heat shield plate 70 have a disposition relation shown in FIG. 7.

That is, the heat shield plate 70 is held on an inner side of the tubular tip portion 110 and disposed on an outer side of the diaphragm 20 to face the flexible plate-shaped section 21 with a predetermined play gap C therebetween in a state in which a pressure of a combustion gas is not received.

Accordingly, when the heat shield plate 70 receives a pressure of a combustion gas through the opening 124, the heat shield plate 70 immediately comes into contact with the flexible plate-shaped section 21.

Then, the diaphragm 20 deforms according to the received pressure while being shielded from the combustion gas by the heat shield plate 70.

Accordingly, heat of the combustion gas is substantially shielded by the heat shield plate 70 and heat transfer to the diaphragm 20 is minimized or prevented.

Accordingly, the flexible plate-shaped section 21 of the diaphragm 20 substantially receives only a pressure of a combustion gas by minimizing or preventing an influence of heat due to the combustion gas.

In addition, since the play gap C of the heat shield plate 70 is set to be in a range of the plate thickness t2 or less of the heat shield plate 70, an impact force according to the movement is reduced, and thus, an impact sound or the like does not occur and also there is no influence on the characteristics of the diaphragm 20.

In this way, since the play gap C is provided, management of a dimension of the second tubular section 121 in the axis S direction is facilitated, and management costs or the like can be reduced.

In addition, the heat shield plate 70 is held on an inner side of the tubular tip portion 110, and is not fixed through welding or the like. Accordingly, as the material of the heat shield plate 70, according to a material in which a heat shield action is obtained, a material other than a metal material can be used.

As described above, even under a measurement environment exposed to a high temperature pressure medium, deformation of the diaphragm 20 due to heat can be minimized, and a contact position between the rod section 22 of the diaphragm 20 and the piezoelectric substance 32 of the pressure measuring part 30 can be maintained in an expected set state. Accordingly, fluctuation of a preload applied to the pressure measuring part 30 can be prevented, and output noise from the piezoelectric substance 32 due to fluctuation of the preload can be prevented.

For this reason, measurement error due to thermal deformation or the like can be minimized, and a pressure of a combustion gas in the combustion chamber CH of the engine can be detected accurately.

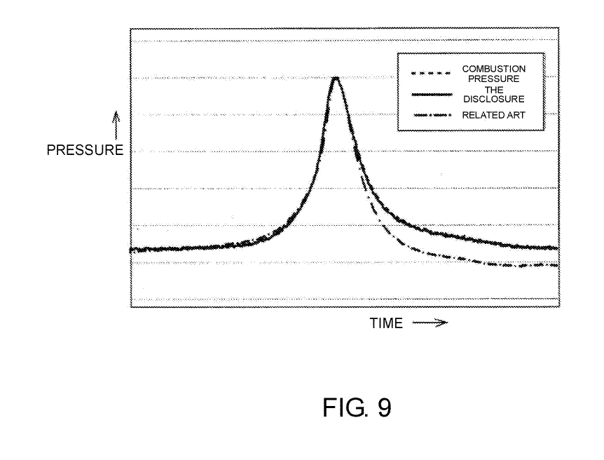

FIG. 9 is a graph showing comparison test data obtained by measuring a pressure of a combustion gas in a combustion chamber of an engine using the pressure sensor according to the embodiment of the disclosure and a pressure sensor in the related art.
Engine used: two-cylinder gasoline engine, exhaust volume 1000 cc
Operation conditions: engine rotation speed 5000 rpm, full throttle
Reference sensor: sensor for precision analysis (manufactured by AVL Co., Ltd.)
Results data: dotted line→sensor for precision analysis (actual combustion pressure), solid line→pressure sensor of the embodiment of the disclosure, dotted-dashed line→pressure sensor in the related art

As is apparent from the results shown in FIG. 9, in the pressure sensor of the embodiment of the disclosure including the heat shield plate 70, in comparison with the pressure sensor in the related art, a deviation amount from the actual combustion pressure, i.e., a measurement error is reduced.

In this way, according to the pressure sensor of the embodiment of the disclosure, sensor accuracy can be improved, and a pressure of a pressure medium such as a combustion gas or the like in the combustion chamber of the engine can be accurately detected.

In the embodiment, while the diaphragm 20 in which the flexible plate-shaped section 21 and the rod section 22 are integrally provided is shown as a diaphragm, the embodiment is not limited thereto, and a configuration in which the flexible plate-shaped section 21 and the rod section 22 are separately formed, the flexible plate-shaped section 21 functions as a diaphragm and the rod section 22 functions as a power transmission member may be employed.

In the embodiment, while a configuration in which the diaphragm 20 functions as the first electrode 31 of the pressure measuring part 30 is shown, there is no limitation thereto, and a configuration in which a dedicated electrode is provided as the first electrode 31 may be employed.

As described above, since the pressure sensor of the embodiment of the disclosure can minimize an influence of heat and accurately detect a pressure of a high temperature pressure medium, in particular the pressure sensor of the embodiment of the disclosure can be applied as a pressure sensor configured to detect a pressure of a high temperature pressure medium such as a combustion gas or the like in the combustion chamber of an engine, and is useful as a pressure sensor configured to detect a pressure of a high temperature pressure medium other than a combustion gas, or a pressure of another pressure medium.

What is claimed is:

1. A pressure sensor comprising:
a housing including a tubular tip portion;
a pressure measuring part including a piezoelectric substance while being accommodated in the housing;
a diaphragm including a flexible plate-shaped section fixed to an inner side of the tubular tip portion and a rod section interposed between the flexible plate-shaped section and the pressure measuring part; and
a heat shield plate held on the inner side of the tubular tip portion to shield the diaphragm from a pressure medium.

2. The pressure sensor according to claim 1, wherein the tubular tip portion includes an annular tip portion that defines an opening having a reduced diameter at a tip thereof, and
the heat shield plate is held by the annular tip portion.

3. The pressure sensor according to claim 2, wherein the annular tip portion is formed by folding an opening edge region of the tubular tip portion inward.

4. The pressure sensor according to claim 1, wherein the heat shield plate is held to come in contact with the flexible plate-shaped section with no load or faces the flexible plate-shaped section with a predetermined play gap therebetween in a state in which a pressure of a pressure medium is not received.

5. The pressure sensor according to claim 4, wherein the play gap is set to be in a range of a plate thickness or less of the heat shield plate.

6. The pressure sensor according to claim 1, wherein the tubular tip portion is formed in a cylindrical shape,
the flexible plate-shaped section is formed in a disk shape disposed on an inner side of the tubular tip portion, and
the heat shield plate is formed in a disk shape having an outer diameter smaller than an inner diameter of the tubular tip portion.

7. The pressure sensor according to claim 1, wherein the tubular tip portion includes a first tubular section, a second tubular section disposed on a tip side of the first tubular section and having a wall thickness smaller than that of the first tubular section, and a stepping surface formed on a boundary between the first tubular section and the second tubular section,
the flexible plate-shaped section is fixed to the stepping surface,
the second tubular section includes an annular tip portion that defines an opening having a reduced diameter at a tip thereof, and
the heat shield plate is held by the annular tip portion.

8. The pressure sensor according to claim 7, wherein the annular tip portion is constituted by a coupling member coupled to the housing to define the second tubular section.

9. The pressure sensor according to claim 1, wherein the pressure measuring part includes a first electrode, the piezoelectric substance and a second electrode, which are sequentially laminated from a tip side of the tubular tip portion, and
the diaphragm functions as the first electrode.
